(19) United States
(12) Patent Application Publication
(10) Pub. No.: US 2006/0105661 A1
(43) Pub. Date: May 18, 2006

(54) Thermoplastic formed panel, intermediate panel for the fabrication thereof, and method for fabricating said panel and said intermediate panel

(75) Inventor: Paolo Steinbach, Como (IT)

Correspondence Address: Serafini Associates, 7660 FAY AVE. STE H378, LA JOLLA, CA, 92037, US

(73) Assignee: EUROPLASTICA S.R.L, Pasiano di Pordenone (IT)

(21) Appl. No.: 10/541,147

(22) PCT Filed: Dec. 11, 2003
(86) PCT No.: PCT/EP03/50990

§ 371 Date: Oct. 3, 2005

(30) Foreign Application Priority Data
Dec. 30, 2002 (IT) SV2002A000063

(51) Int. Cl. D04H 13/00; B32B 5/26; D04H 1/00

(52) U.S. Cl. 442/327; 442/414; 442/381

(57) ABSTRACT

The invention relates to a thermoformable panel. According to the invention, the panel is composed of thermoplastic fibers forming a nonwoven fabric particularly having double crossed, randomized and thermally bonded webs, pressed under heating to cause a partial “melting” of the fibers, i.e. at least a partial loss of their fibrous phase and change into a viscous or viscoelastic phase, the relative distributions of the fraction of fibers that retain the fibrous phase and the fraction of plastic material that took the viscous or viscoelastic state depending on the depth thereof in the sheet thickness. The invention further relates to a formed, especially a highly embossed panel made of a thermoformable plastic material. The latter may be an intermediate semifinished product of a starting material. The invention also relates to a method for fabricating highly embossed panel. Particularly, the invention relates to a formed, especially a highly embossed panel and to the method for fabrication thereof, which highly embossed panel finds use in the automotive, naval, aerospace, railway and building industries, for the fabrication of interior or exterior coverings or structural members.

The invention relates to a thermoformable panel made of a thermoplastic material.

Thermoformable thermoplastic panels or sheets are widely known in many variants and used in various fields for the fabrication of different products.

These sheets may be particularly used in the fabrication of formed, especially highly embossed panels with many different well-known thermoforming techniques. These formed, especially highly embossed panels may be used in several fields, e.g. in building, either for interior and exterior finishing, or as a material for building structures, like formworks used to contain concrete or the like and/or as acoustic isolators. The fabrication of furnishings, i.e. furniture or the like is also included in the field of application of thermoformed panels, and particularly these panels are widely used in the automotive industry, and in the production of vehicles in general, i.e. ground, naval or aerospace vehicles, for instance in the fabrication of interior panels, like trim elements of automotive vehicles or the like.

In the naval, aerospace or railway fields, thermoplastic panels may be used either as trim materials for coverings or the like, in the same manner as for automotive vehicles, or as structural members for the fabrication of partitions, bulkheads, roofs, floors, etc. In these fields, and particularly for modern ships or high-speed trains, the use of plastic panels is particularly advantageous, due to the considerable lightness thereof.

The panels designed for the above mentioned purposes are required to have several aesthetic, physical, mechanical, formability and cost features that are often in contrast with each other and hardly obtainable to the same extent. Obviously, these panel features also affect the features required of the thermoformable sheets wherefrom panels are obtained.

While considering the need of minimizing costs, the panels shall be as light as possible, while having high mechanical strength properties. Conversely, these panels, as well as the sheets whereof they are made, shall ensure high deformability or formability because, particularly in the automotive field, the requested three-dimensional shapes include considerable shape variations, hence sheets shall allow deep drawings during panel forming. While lightness requires relatively rigid structures, having precise symmetries and anisotropies, which means that sheets shall exhibit a suitable internal structure for forming grids, interlacements, leases which, as the material is compacted, generate stiffening ribs or knots, this need is in conflict with some of the required mechanical properties, especially with the high embossing required of sheets. Particularly in plastic materials, the fibrous phase, i.e. including plastic molecule agglomerations requires an elastic or almost elastic condition of said material, whereas the need of allowing a high three-dimensional embossing requires a good flowability of thermoplastic molecules, i.e. a phase that may be defined as viscous or viscoelastic, and may be typically obtained by heating the material to a temperature below the melting point, which causes an effect of a transition in the viscous or viscoelastic state, instead of melting.

The elastic condition and an important substantially fibrous phase allow the material to be properly stiffened, and improved in terms of tensile, torsional and compression strength. Certain particular fields of use require also that when the material is broken, it is free from sharp edges (e.g. like in traditional glass breaking arrangements). There is therefore a need of a material which has at the same time a resilient and an elastic behaviour and showing also a so called “ductile breaking”, i.e. without forming sharp edges at the broken region. In other fields, like in building, the material is required to have an optimal behavior in terms of mailability. Concerning mailability, the ideal behavior consists in allowing nail penetration without causing veining, breaking or cracking, branching off the penetration point. As an ideal behavior, the material is required to receive the nail and form a corresponding hole area, the material being only substantially broken at the nail hole area. Also, considerable advantages may be obtained by using a material that may retain a certain elasticity in the nail penetration area, to at least partly close the nail penetration hole, once the nail is removed therefrom, to obtain a certain self-repairing action in the sheet or in the panel formed therefrom. Therefore, the material is advantageously required to be able to expand at least partly to at least partly reduce or almost wholly or wholly close the hole.

The above particular needs are in contrast with rigidity, flexibility and mechanical strength needs that require a more resilient structure of the panel material, and of the sheet material wherefrom the panel is obtained by a forming process.

Panels are often required to be covered with outer layers having both aesthetic and protective functions or other field-specific functions. In this case, the material of the panel and the sheet wherefrom the panel is made, shall be chemically and physically compatible with usual covering materials, i.e. for example thin sheets such as adhesive materials to improve fixation of covering layers. In order to increase formability, panels are also often laminated on the backside with nonwoven fabrics of synthetic or natural materials. Restrictions are also provided regarding the type of plastic which forms the panels and sheets. These restrictions are further limited due to the increasing interest for environment protection, which requires sheets and panels to be preferably made of materials that are as recyclable as possible. Particularly, sheets and panels should allow an at least mechanical fixation of the covering layer fibers or surfaces within the sheet material, by partial embedding thereof in the matrix of the surface layer of the sheet plastic material.

Depending on the field of application and use of the panel, other physical, aesthetic and mechanical properties may be also required. In certain instances, an at least partial surface compliance is required of the panel, i.e. a certain softness thereof. This may be also desired in certain particular areas of the panel. On the other hand, such softness shall coexist with a certain mechanical strength and rigidity and with the other properties mentioned above. In prior art, this is obtained by forming closed- or open-cell foamed sheets. However, these sheets often do not provide panels having high mechanical strength properties, and foam layers must be backed by supporting or stiffening layers. On the other hand foams often collapse during forming.

If mechanical strength requirements are so high that they cannot be provided by a single-layer sheet, even when the latter is not made of foam, the sheet must have a composite, i.e. multilayer construction, and include at least one stiffening layer made of thermoformable plastic or natural materials or stiffening lattice structures, and this obviously limits sheet formability.

Further characteristics are associated to the requirement of thermal and acoustic insulation properties, as well as tactile effects, e.g. for panels required to be warm to the touch or the like.

In prior art techniques for fabricating thermoformed products as described hereinbefore from thermoformable sheets, polyolefin sheets are currently used, which are mixed with fillers like wood flour, talc or the like and natural fibers, such as vegetal fibers or plastic fibers, to remove or reduce the generation of sharp edges or tips upon fracture. Adding talc to the panel material causes a fragile behaviour of the panel

The above arrangement, resulting in only partly satisfactory results, also requires sheets to be previously processed to mix thermoplastic materials with fibers and fillers, and fibers are often not optimally embedded therein, causing a non uniform quality of the sheets. Also, natural fibers shall be treated against microbiological and mycological agents which cause degeneration and decomposition thereof, as well as the generation of unpleasant odors. Moreover, these degeneration effects cannot be completely obviated and the sheet is always exposed to quality degeneration, also due to atmospheric agents like moisture or direct exposure to water.

The methods for forming sheets and applying various covering layers thereto, include various combinations. Sheets are typically obtained by extrusion, regardless of their being made of a foamed or compact material. A general draw back of extrusion consist in the fact that during extrusion it is very difficult to distribute uniformly the fibers in the mass of the polymeric material. Extrusion exercises a shearing stress on the fibers which causes a breaking of the long fibers. This reduction in length of the fibers has a direct consequence a reduction of the resilience of the material. Furthermore the fibers are admixed to the polymeric mass during extrusion and this fact causes an anisotropy of the fibers distribution in the polymeric mass and in the extruded product leading to local differences of specific weight within the extensions of the extruded product and thus in differences in the mechanical behavior at different points or regions of the extruded product.

Forming is carried out by heating and compression inside a mold. Various methods are used, such as thermocompression or mold and countermold forming, hydraulic or pneumatic pressure against a rigid surface of a mold, vacuum forming or suction of the sheet against a rigid forming surface or hybrid methods which include the above compression methods, at least for certain areas or in combination with each other.

It is further widely known to apply, when required, covering layers, adhesives or other layers of material during the forming process.

Prior art alternative methods are to be also mentioned herein, particularly for the fabrication of panels formed with deep recesses and/or ridges, which methods consist in injection molding. As compared with the panel fabrication methods including flat sheet forming, these methods are considerably more expensive and complex, particularly as regards the fabrication of panels covered by or composed of multiple layers, and not suitable for integration of a fibrous structure therein.

Especially the last kind of process leads to materials having a fragile behavior relatively to breaking and usually there are limitations relatively to the different materials which can be used for lining the panel, particularly but not limited to a process known in the art as low pressure molding.

Document U.S. Pat. No. 4,258,093 discloses a panel having a three dimensional shape, typically of concave-convex form and having sufficient rigidity to maintain that form. Such panels are molded from nonvowen, needlepunched fabrics containing certain ethylene-vinil acetate fibers in admixture with fibers of a higher melting point polymer. Molding is accomplished by heating the fabric to a temperature whereat the ethylene-vinyl acetate fibers soften or melt but below the melting point of the other fibers and thereafter pressing the fabric between the mating surfaces of a mold pair and allowing the ethylene-vinyl acetate fibers to solidify and cool while in the mold.

U.S. Pat. No. 4,818,586 discloses a similar panel made of nonwoven textile fibers, The synthetic thermoplastic fibers are also needlepunched to produce a carpeting material which can then be directly utilized or thermoformed to retain the desired shape.

EP 0174813 discloses a three dimensional molded article suitable for use as a fibrous surface panel for automobile trunk compartments and the like. These articles are produced by molding a heated non woven web formed of a blend of relatively high melting fibers and relative low melting fibers. The low melting fibers form a multiplicity of bonds which impart shape retentive rigidity to the non planar three dimensional web. The low melting fibers present at one surface of the web have a fibrous form, while the low melting fibers present at the opposite surface of the web have portions which exhibit a non fibrous fused form and form said bonds.

U.S. Pat. No. 5,362,546 discloses a three dimensional non woven fabric with a thermally activated adhesive surface. The fabric is used as a facing fabric for covenrign a fibrous mat. The fabric comprises two adjoining fibers layers, namely an adhesive layer including bod forming fibers fusible at a predetermined temperature and a facing layer of fibbers having a considerably higher melting temperature than the bond-forming fibers. The fibers of both layers are mechanically engaged one with another and are arranged flatwise in bundles interconnected at junctures by protuberant fibers packings disposed in a staggred relationship throughout the fabric. Bond-forming fibers are concentrated in the apex portions of the fiber packings to form thermally activated adhesive surface. These non woven fabric facing fabric layer can be used in combination with a non woven molded fibrous mat.

DE 198 12 925 discloses a three dimensional formed article comprising a needle punched non woven mat formed by two or more layers structurally neddled together. A first layer comprises a blend of polypropylene fibers and polyethylene fibers and a second or further layer comprises a blend of polypropylene fibers and polyethylene fibers. Both layers are bonded together by needlepunching and by melted fibers or part of the fibers of the polyethylene fibers component of both layers.

Document WO0059716 discloses a thermoformable panel comprising a non wiven fibrous composite which has at least two functional layers made of the same nonwoven thermoformable polymeric chemical substance or material. The polymeric chemical substance is fabricated into two different fabric having different mechanical and/or other physical properties. At least one of the fabric is a formable fabric which upon final molding under heat and/or pressure posses a relatively high degree of strength and stiffness. The other fabric is a variable compression fabric, i.e. a variable thickness fabric, which is capable of assuming variable thickness and density when subjected to molding under heat and pressure.

Other documents such as EP 0 239207, U.S. Pat. No. 4,302,495, EP 1238794 discloses a moldable or molded panel fomed by at least two layers one of these layers is a sort of scrim or net which is laminated by heat and compression and/or by needling to a layer formed by a mat of fibers.

Documents U.S. Pat. No. 5,122,213, EP 0305207 and GB 233741 discloses a multilayer thermoformable or thermoformed panel comprising at least a layer made of a nonwoven fabric of thermoplastic fibers.

The above mentioned prior art teaching may be divided in three categories. In a first category a formed panel is provided made by heating and compressing in a mold a nonwoven and needled fabric of thermoplastic fibers. The thermoplastic fibers are of at least two kinds each one having a different melting or softening temperature and the heating is carried out a a temperature which is lower than the melting temperature of the fibers having the highest melting temperature. Thus only one kind of fibers looses at least its fibrous phase passing in the viscous or viscoelastic phase and providing the bonding of the fibers of the thermoplastic material having the higher melting temperature. These fibers do not loose at all their fibrous phase and are sticked together by the melted fibers of the thermoplastic material having the lowest melting temperature. These kind of panels never will show portions of their thickness in which the prevalent part of the fibers has lost the fibrous phase and in which the plastic material is passed at least for the major or prevalent part of the fibers in the viscous or viscoelastic phase. This structure of the panel does not satisfy the need of high rigidity and elasticity. The bonds of the thermoplastic material having maintained it fibrous phase are not as stable in time and the surface will show a certain porosity thus being subject to letting pass water vapor or water which can accumulate in the panel. The retention resistance of mechanical means such as screws or needle is not very good since transverse forces acting on the needles or screws can progressively cause the seat of the screw or of the needle to be enlarged thus causing a progressive loosing of the retention force of the needle and of the screws in the panel. This is particularly negative when such panels are used for lining the internal parts of cars or the like where the panels are submitted to strong vibration stress. Furthermore the non woven fabric of thermoplastic fibers require needle punching. These is in contrast with a good behavior when the three dimensional forming requires deep convex-concave shapes of the panel since the transversally oriented fibers through needle punching cat against a good flow of the fibers in the directions parallel to the panel surface. These means that two high reductions in thickness and thus weaker zones of the panel ar obtained at the deep convex or concave shaped regions of the formed panel.

A second teaching relating to the prior art documents cited above provides a multilayer construction of the panels in which at least one layer is provided for the function of giving the necessary rigidity and strength and the further layers ahs the function of a cushion or thickness layer which provides for different mechanical and aesthetic and/or insulating functions. Different kinds of layers are suggested by the prior art documents which give different results in the mechanical properties of the panels. Nevertheless several different layer are in any case required and these causes higher costs and relatively complex production processes. To the skilled person it appears evident that the above mentioned different kind of panels of the prior art provides each one for different mechanical and/or insulating and/or aesthetic features so that each kind of panel is better suited for a particular use or a particular situation.

Therefore, the invention is based on the problem of obtaining a thermoformable sheet or panel, that allows to obviate the drawbacks of prior art sheets, particularly with reference to the fabrication of formed panels, either covered or not with other finishing layers, thereby providing the best compromise among structural requirements of the panels, aimed at obtaining optimized aesthetic, physical and mechanical properties, or providing at least variable combinations of said optimized properties, relative to a specific use, by using substantially the same panel structure and only varying the panel forming process parameters that are easily adjustable without substantially affecting the steps of well-known forming methods.

The invention achieves the above purposes by providing a thermoformable panel, which is composed of interlaced thermoplastic fibers forming a non-woven fabric, pressed under heating to cause al least partial “melting” of fibers, i.e. at least a partial loss of their fibrous phase and change into a viscous or viscoelastic phase, the relative distributions of the fraction of fibers that retain the fibrous phase and the fraction of plastic material that took the viscous or viscoelastic state depending on the depth thereof in the sheet thickness.

As a function of the depth in the panel thickness the fibers shows a continuous change of phase from a first phase provided at the two opposite faces of the panel and in which phase all or almost all the fibers has been submitted to a “melting”, i.e. in which all or almost all the fibers has completely or almost completely lost their fibrous phase passing in a viscous or viscoelastic phase into a second phase at an intermediate, preferably central region of the panel where the fibers has completely or almost completely maintained their fibrous phase, i.e. has maintained their shape and individuality.

Preferably, this panel is made starting forma a mat which is composed of several thermoplastic nonwoven sheets or webs of fabric layers which are crossed one with respect to the other and has a randomized fiber distribution, the said webs or layers being bonded by mechanical interlacing and/or by physico-chemical bonds such as thermal bonding.

When the thermoplastic material is a blend of at least two kinds of thermoplastic fibers having different melting and/or softening temperatures the said blend of thermoplastic fibers having the following continuous phase variation as a function of the depths of penetration:

a first phase provided at the two opposite faces of the panel and in which phase all or almost all the fibers of the at least two kind has been submitted to a “melting”, i.e. in which all or almost all the fibers of the at least two kind has completely or almost completely lost their fibrous phase into a second phase at an intermediate, preferably central region of the panel where both the fibers of the at least two kind the fibers of only one kind has completely or almost completely maintained their fibrous phase, i.e. has maintained their shape and individuality, passing through intermediate phases at intermediate depth of penetration in the thickness of the panel where the fibers of one kind has a more rapid change as a function of penetration in the thickness depth than the fibers of the at least second kind, thereby providing at intermediate penetration depth between the surface of the panel and the central portion a first kind of fibers having a prevalent part of them in a fibrous phase and at least a second part of fibers having a prevalent part or almost all of them in a viscous or viscoelastic phase and/or with further increase in the depth of penetration toward the central portion of the panel a first part of fibers having a prevalent part or almost all of them a fibrous phase while the at least second kind of fibers having formed physico-chemical bondings between the first kind of fibres.

The function of variation of the phase of the at least one or two or more kinds of thermoplastic fibres is continuous and can be linear or non linear and can be further also different for each kind of thermoplastic fibres in a blend of thermoplastic fibres forming the nonwoven starting mat.

In a preferred embodiment the function describing the dependence of the phase variation of the thermoplastic fibres form the penetration depth in the thickness of the panel is approximately symmetric relatively to the central plane of the panel.

For obtaining such a panel structure with a continuous variation of the phase of the thermoplastic fibers along the thickness of the panel a mat of nonwoven fabric layers is submitted to hard or violent heating of at least one, preferably of both faces and at a predetermined melting and/or softening temperature of the fibers which is considerably higher than the melting temperature of the plastic fibers of the panel having the highest melting or softening temperature and for a predetermined time.

Carrying out several experiments it has been surprisingly find out that the relevant parameter is not the temperature only but also time. A current theory considers more appropriate to define as the relevant parameter the total amount of the thermal energy transferred to the material. A further feature which is to be considered relevant is the method of transferring the thermal energy to the material in order to obtain a so called “hard or violent heating”. In the meaning of the present invention “hard or violent heating” means a heat transfer means having a very low thermal capacity for limiting penetration in the thickness of the starting sheet of material. In this situation the temperature of the heating means at the emission sirface can be very high still obtaining a heating of the panel at a mean temperature which might be lower than the softening temperature of the thermoplastic material but sufficient to cause the transition of the fibrous phase to the viscous or viscoelastic phase at small depth in the panel thickness referred to the external surfaces of the panel. According to the above a very appropriate heating means are formed by infrared heaters.

According to the above the method of the present invention gives the effects and results aimed also when the temperature at which the panel is heated is about the softening temperature of the fibers or even lower. Depending on the dependence of the variation of the state of the fibers along the thickness of the panel the times may be varied and the heating temperature ca be correspondingly increased or decreased or maintained at a certain level.

The panel may be than submitted to a further step of compression to such an extent as to cause a thickness reduction from the uncompressed condition to the compressed condition by about 30% to about 90% of the uncompressed thickness of the mat made of the nonwoven fabric layers.

During such a compression step the panel can also be shaped in a three dimensional form.

It has been surprisingly discovered that violent heating carried out preferably by means of infrared radiation onto the panel surfaces provides for high temperature and a slow internal heat transfer which allows the continuous variation in the phase of the thermoplastic fibers along the thickness of the panel.

The forming pressure may be exerted by using any prior art forming techniques and particularly by using a mold and countermold system made of metal or by pressing the sheet with the help of a fluid, either in the liquid or gas phase, against a rigid forming surface, or by drawing the sheet against said forming surface.

Sheet forming may be also carried out by combinations of the above methods, e.g. vacuum forming and pressure forming with a pressure fluid against a rigid forming surface and/or by providing forming pressure by one of the above methods in certain portions of the panel, and one of the other methods in other portions, or even a combination of fluid pressure and vacuum forming methods in other portions.

Although the best results has been obtained by infrared radiation violent heating can also be carried out by using any prior art methods, such as by contact with heated surfaces, radiation and/or exposure to a hot air or fluid flow.

Thanks to these process the formed panel has a surface layer, on at least one of its faces preferably on both its faces, in which the thermoplastic material has turned into a viscous phase, at least a prevailing portion of said material, preferably all or almost all the said material being in said viscous phase, whereas in the inward direction, toward the central plane of the panel the thermoplastic material that retains its fibrous phase increases and the thermoplastic material having a viscous or viscoelastic phase decreases, and possibly disappears.

When heating is carried out on only one face of the panel then the said variation of the phase from the visous or viscoelatic phase at the heated surface and at the immediately adjacent portions in the thickness of the panel to the progressively fibrous phase in the direction of the opposite face are referred to the said opposite non heated face of the panel instead than to the central plane.

The panel faces can be also submitted to a differentiated heating in such a way as to obtain a non symmetric function of the variation of the phase of the thermoplastic material along the thickness of the panel between the two opposite faces.

The distributions of viscous or viscoelastic components and fibrous components may be varied as desired by adjusting heating parameters and methods and compression thicknesses of sheets. Particularly, such arrangements are affected by heating temperature variations across the sheet layers as a function of the depth thereof relative to the thickness of the panel, as well as by the final compression thickness of the panel relative to the starting thickness of the sheet.

Thanks to the above, nonwoven mat of thermoplastic material may be used to make formed, particularly highly embossed panels, by any well-known thermoforming method, whose surface material has a sufficient flowability as to allow deep drawing operations, whereas in the intermediate portion of the sheet and/or the portion extending to the sheet face that is meant to form the rear, unexposed face of the panel, the prevailing component of the material retains the fibrous phase and/or the retention of the fibrous phase, as well as the fiber compacting action due to the forming pressure provide rigidity and mechanical strength, breaking behaviors that do not involve sharp edges and or tips, as well as a heat or acoustic insulation effect and an excellent nailability, and improves the closure of the nail hole when the nail is removed therefrom.

In accordance with a preferred embodiment, the invention includes a preliminary treatment of a sheet consisting of a multi-layer mat of thermoplastic fibers, particularly obtained by superimposing two or more layers of fabric or web made of thermoplastic fibers which layers are crossed one with respect to the other in a randomized way and which layers are preferably thermally bonded and/or eventually mechanically bonded to obtain an intermediate or semi-finished sheet to be used, by additional forming treatments like those described above, to make a panel according to the invention.

Therefore, the invention relates to an intermediate product, consisting of a thermoformable thermoplastic plane panel, which is obtained by compacting a mat of nonwoven thermoplastic fibers after the violent heating of the faces of the mat according to the process described above and obtaining a phase variation of the thermoplastic material as described above.

According to a preferred embodiment of a process for fabricating a plane thermoformable panel or a three dimensional shaped panel a further step is provided consisting in precompressing the mat of non woven thermoplastic fibers before submitting it to the violent heating at its face or faces.

A preferred but non unique way of carrying out precompression is calendering.

Calendering is preferably carried out while contemporarily heating the mat of thermoplastic fibers and/or after having heated the mat of thermoplastic fibers at a temperature which is at least lower than the “melting” and/or softening temperature of the thermoplastic fibers having the highest or the lowest melting and/or softening temperature.

These preprocessing step reduces the risks of a deformation of the mat of nonwoven fibers during the step of violent heating at the face or at the faces of the said mat.

Relating to the flat panel as an intermediate product for producing thermoformed and particularly highly embossed panels the great advantage lies in the fact that in this intermediate product, air between fibers in the nonwoven fabric layers of the starting mat is at least partly removed, and besides being compacted, fibers are also at least partly at the viscous or viscoelastic state, whereby at least a portion of the thermoplastic material in the surface layers of one or both faces turns into a viscous or viscoelastic phase.

Here again, the shaping can be carried out by completing the violent heating process at the faces of the flat panel and shaping the so heated flat panel in a mold countermold system thus obtaining the variation of the phase of the thermoplastic material disclosed above within the thickness of the three dimensional shaped panel.

When particularly wide shapes are provided, with deep and steep recesses and ridges, the functions for controlling relative distribution changes of the viscous or viscoelastic component and the fibrous component shall ensure that the viscous or viscoelastic component is always prevalent at higher depths within the sheet thickness with reference to one or both faces of the sheet. In other instances, when, for instance, the finished panel properties are provided by the fibrous component of the material and neither deep and/or steep recesses nor high and/or steep ridges are provided, then the function used to control the distribution of the viscous or viscoelastic component relative to the fibrous component of the material may be such that the viscous or viscoelastic component is prevalent in thinner surface layers or that a viscous or viscoelastic component is generated that never prevails over the fibrous component. Similarly, a distribution may be provided in which the fibrous component never prevails over the viscous or viscoelastic component of the material, regardless of the depth within the thickness of the sheet or finished panel.

Obviously, while the structure of the intermediate semi-finished flat panel in terms of relative distribution of the fibrous component and the viscous or viscoelastic component of the material may be adapted to the fabrication of a particular three dimensional especially highly embossed panel type, i.e. having a particular shape and/or, particular mechanical and/or, physico-chemical and/or aesthetic and/or other properties, the inventive panel provides substantially reproducible results starting from any intermediate panel structure, thanks to the fact that heating parameters or heating temperature distribution parameters may be set relative to the depth in the sheet thickness in the subsequent final forming step, in such a manner as to influence the function that controls the distribution of viscous or viscoelastic components and of fibrous components of the material, as required and desired in the finished formed panel.

The finished formed panel, or the intermediate flat panel may be all provided in combination with one or more additional layers of material, to be applied on one or both faces, and to be used as covering, protecting, stiffening, adhesive or barrier layers.

The methods for applying these layers are widely used in the art of lamination, and may provide that layers be applied directly in the compacting or forming mold and/or in a lamination plant, by calendering or the like.

Furthermore, the various layers may be made of materials in granular or powder form, which are heated to a flow point, provided that this is possible without corrupting the structure of the mat and/or intermediate panel and/or final formed, particularly highly embossed panel in terms of relative distribution of the fibrous component and the viscous or viscoelastic component or in terms of other physical phenomena, like collapse, shrinkage or melting of the thermoplastic material of the sheet.

The covering layers may be of any type, i.e. made of either a plastic material or natural materials, like fabrics, meshes, nonwoven fabrics, interwoven fibers, needlefelts, mats, thin sheets of natural or synthetic fibers or other types of materials, like paper, leather, and/or synthetic leather, or others.

A very important advantage of the panel according to the present invention consists in the fact that the panel shows an elastic inflation or dilatation process. These ensures that on one hand the shaped panel always exactly fits the shape of the mold and countermold system. It is a well known effect to the skilled person that in shaping panels with a three dimensional form particularly when deep convex or concave shapes are provided, the shaped panel does often not exactly reproduce the shape of the mold and countermold due to various shrinking effects and effects of compensation of internal tensions or strechtes. These effects requests to add material at certain points of the molds or countermolds where a deviation of the shape of the panel relatively to the shape of the mold or countermold has been discovered. This process is an empirical time consuming process based on successive trials and of the analysis of the results obtained and is hardly reproducible or can be hardly transformed in a reproducible process. The above mentioned effect also obliges to provide mold and countermold which shapes has differentiated distances at different regions in order to provide for a compensation of the said effect. Due to the elastic swelling or dilatation behavior of the panel according to the invention the three dimensional shaped panel either obtained by directly three dimensional shaping of the heated nonwoven web or mat of thermoplastic fibers or by three dimensional shaping of an intermediate product consisting in a flat panel according to the present invention the said formed panel always exactly reproduces the shape of the mold and countermold obviating to the need of carrying out the said compensating process. Furthermore when such a panel according to the invention is provided with an external layer of synthetic skin which has to be provided with an embossed pattern the swelling allows to obtain a better embossed pattern.

The invention further relates to an interior panel for a vehicle, i.e. an interior trim panel, which is made according to the above description. Such panels are found, for instance, in the backs of seats, in door trims, in rear seat side trim panels when no rear doors are provided and other covering elements.

The invention also relates to a panel for building purposes, both for formworks and for fabricating interior and/or exterior coverings of building words, as mentioned in the above description.

It shall be noted, anyway, that, a high versatility in the adjustment of mechanical strength, flexibility, elasticity and aesthetic features of the sheet and the inventive panel, the latter may be used in any field with no limitation.

The invention further relates to a method for fabricating the panel according to the steps described above.

Regarding the thermoplastic materials of the mat of fiber, any plastic material may be used.

Particularly, the invention provides the use of polar or non polar polymer and/or copolymer fibers.

Amongst non polar polymers or copolymers, polymers or copolymers selected from the group of polyolefins are preferably used.

Especially, the invention provides the use of polyethylene polymers or copolymers and/or polyethylene derivatives and, as a plastic material, the invention advantageously provides the use of a polyethylene ether, such as polyethylene glycol ether phthalate.

The advantages of the present invention are self-evident from the above description. These advantages mainly consist in the provision of a thermoplastic formed panel and of an intermediate flat or plane panel that, thanks to precise heating and compression parameter settings allow to optimally adjust, from the same starting mat-like sheet, mechanical strength, elasticity, formability and chemical/physical, aesthetical and heat and/or acoustic insulation properties, as well as nailability, with respect to the application wherefore the panel is designed.

The panel may be made of a single material, whereby it is highly recyclable. Also, the panel may include portions having different thicknesses and compression strengths, for instance softer or stiffer portions, which may be obtained by adjusting either the thickness of the material and the local heating temperature, thereby obtaining effects that may be currently attained almost exclusively by injection processes or with foam materials, while still providing high mechanical strength properties.

The total lack of natural, particularly vegetal fibers, for fillers or reinforcements obviates all the problems associated with microorganisms or flora, which may decompose natural fibers and cause degradation of the panel properties, as well as the generation of odors or mold deposits, or the like. Also, the panel is substantially unaffected by moisture and water, and maintains its properties unaltered even in extreme moisture or water immersion conditions.

As far as construction is concerned, the inventive panel may be processed with any prior art panel forming method, using thermoplastic sheets that are not in the fibrous phase, but in the amorphous or viscous or viscoelastic phase. Therefore, the fabrication of the panel, either covered or uncovered, requires no substantial change to current thermoforming plants, except as regards improvements or changes to the heating means and the units for controlling them.

Also, as regards the application of the covering layers by lamination in a calender or in the forming mold, no substantial change is required to the existing plants which use the known sheets.

The intermediate flat panel, including compacted fibers, allows to obtain a size reduction for panel forming, which involves a substantial reduction of both handling and storage costs.

Moreover, the intermediate flat panel may in turn be previously coupled to adhesive or finishing layers that are successively submitted to three dimensional thermoforming with the flat panel during the panel forming process and may be coupled during the mat sheet compaction step into the intermediate panel.

The method according to the present invention has several advantages which can be best defined by the behavior of the panel obtained therewith.

The violent or hard heating in the sense defined above at the surfaces of the non woven starting sheet either in the form of a non woven multilayer mat or already in the form of a flat panel as an intermediate product allow to obtain a variable amount of the fibers changing their state from the fibrous state to the viscous or viscoelastic state starting form the surfaces of the panel and in the direction of an intermediate region of the panel relating to the thickness of the panel. The prevalent or exclusive amount of fibers having a viscous or viscoelastic state at the less deeper regions of the panel forms two external layers which help in distributing deformation forces in a homogeneous way onto the deeper regions of the panel. The prevalent and/or exclusive amount of the fibers having maintained their fibrous condition at the more internal regions of the panel relating to the thickness gives rise to a better formability behavior since the fibrous state of the fibers ensures a better flow of the material in the internal regions during forming, particularly during high or deeply embossing the panel and the above already mentioned swelling effect. Furthermore the panel shows a resilient and elascitc behaviour having sufficient rigidity and also at the same time a ductile breaking behavior. The resilient behavior of the panel is principally due to the fact that the fibers are not broken or lsewhere shortened by the process. Thus the panel shows an uniform specific weight and uniform mechanical properties allover it extension.

The panel according to the invention does not at all collapse during forming and does not suffer of high local thickness reduction in highly embossed regions. Furthermore the panel according to the present invention shows a very low thermal capacity and at the same time a high thermal conductivity.

The precompression step, particularly by calendering allows to carry out the violent or hard heating without suffering of various deformation effects like curling or similar deformations.

Further claimed characteristics relating to the steps and parameters for fabricating the intermediate panel and/or the finished formed panel and other claimed improvements, are described in the following description.

The characteristics of the invention and the advantages derived therefrom will appear more clearly from the following description of a few non limiting embodiments shown in the accompanying figures, in which:

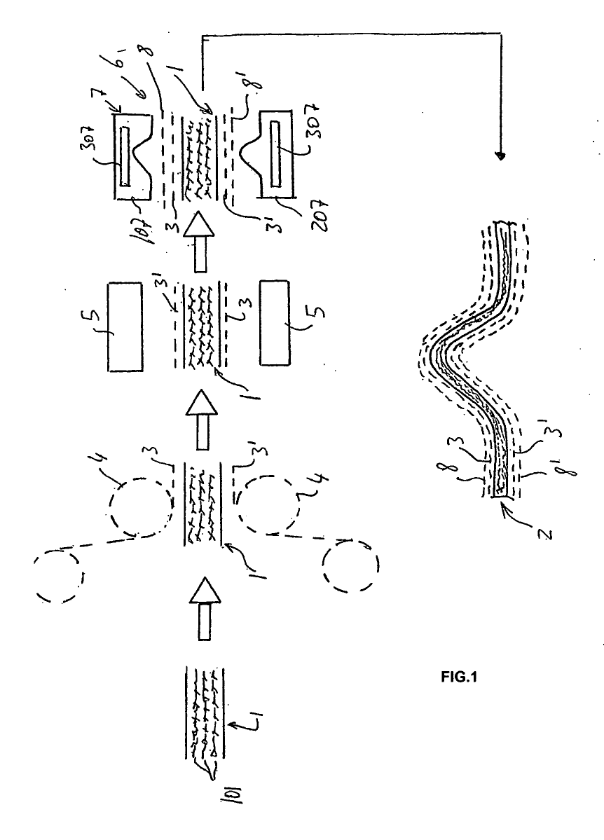

FIG. 1 is a block diagram of an example of the process for producing a panel according to the invention, with various alternatives being shown in dashed lines.

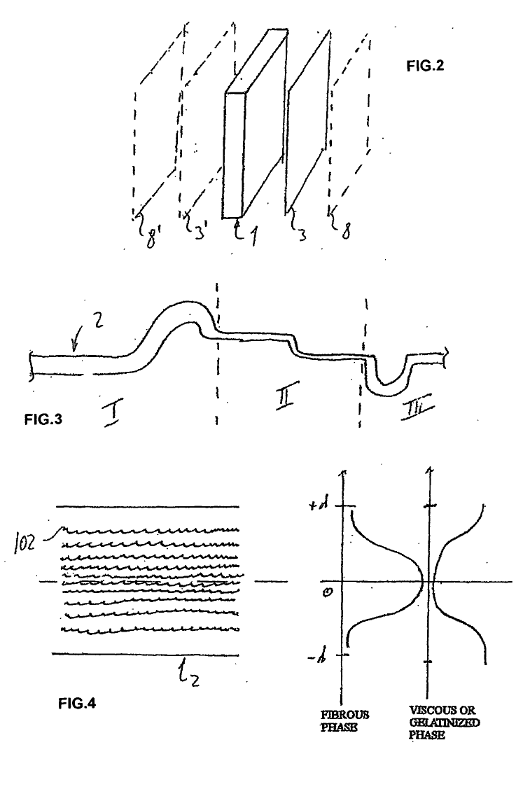

FIG. 2 is a schematic, exploded view of the layer structure of a panel, with all the possible layers being outlined by a discontinuous line.

FIG. 3 is a cross section through a formed panel, the covering layers being omitted therefrom, and in which Figure the panel has three portions I, II, III having different thicknesses.

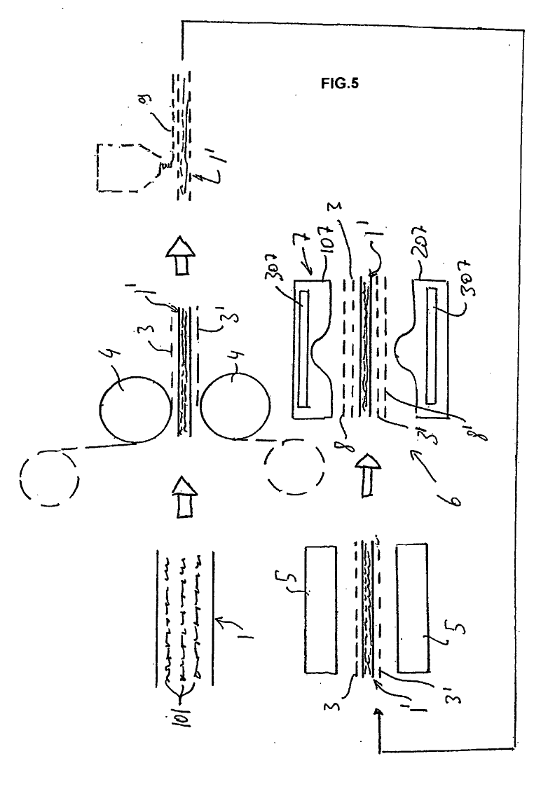

FIG. 4 is another schematic view of an exemplified distribution of the plastic components of the panel or intermediate sheets, which have fibrous properties and viscous or viscoelastic properties respectively, the first function on the left relating to the distribution of the fibrous component and the second function on the right relating to the inverted distribution of the viscous or viscoelastic component.

FIG. 5 shows, like FIG. 1, a method for generating, by separate and successive cycles or in a single production cycle, an intermediate sheet to be used to form a formed panel, the various alternatives being outlined by a broken line.

Referring to FIG. 1, a thermoplastic formed panel 2, particularly made of polyolefin polymers or copolymers and especially of polyethylene derivates, such as polyethyleneglycol ether phthalate, is obtained by compression of a starting sheet 1, which consists of a mat made of interwoven, fibers and/or in the form of a so-called nonwoven fabric heated at a given temperature, as will be described further in greater detail.

The starting sheet 1, which is provided as a mat, may have at least one or more nonwoven fabric layers of said thermoplastic fibers, designated by numeral 101, which are placed one over the other. Preferably the lauers of fabric or webs are crossed one with respect to the other in a randomized way and the single lyers are bonded together thermally. The fibers in the mat are not compressed or only weakly compressed.

A reinforcing layer can eventually be applied on one or both faces of the mat 1, e.g. a net, thin sheet or fabric, a plastic nonwoven fabric, preferably made of a plastic material that is compatible with that of the mat fibers. The two possible layers are outlined with broken lines, and designated by numerals 3, 3′. Although if not necessary, nevertheless the layers may be attached by physico-chemical bonding, i.e. by heating the parts to a bonding temperature and compressing the mat and the layer/s 3, 3′ together. The layers 3, 3′ may be attached in any known manner, which are generally shown, without limitation, by pressure rollers 4, e.g. heated by a calender or the like, the distance therebetween being adjusted in such a manner as to substantially maintain the starting mat thickness after attachment of the layers 3, 3′.

The mat 1, with or without one or both layers 3, 3′ is used for forming a panel by a hot forming method.

To this end, the mat 1 is heated by heater means 5 and is fed to a forming and compression station 6.

Any well-known forming methods may be used for forming and compression.

FIG. 1 shows a mold 7 which includes a mold part 107 and a countermold part 207. Alternatively, forming methods may be used in which a single mold part 107 or 207 is provided, and pressure is exerted by a pressure fluid. Similarly, the surface of the mold part may be vacuum operated and compression against it may by obtained by vacuum. Combinations of the above methods may be also provided, acting over the whole surface of the sheet 1 to be formed into the panel 2 or in a differential manner over different portions of the sheet 1.

The panel 2 resulting therefrom may be an uncovered panel 2 or have a multilayer structure, as shown by the broken lines outlining the covering layers, made of adhesive materials or the like, that may be used as panel finishes and are designated by numerals 3, 3′ and 8, 81. Particularly, during the forming process, which is carried out with well-known techniques, one or more covering layers may be attached on one or both faces of the panel, in addition to any layer 3, 3′ previously applied to the starting sheet 1.

The covering layers may be made of any material, such as thin plastic sheets, fabrics, nonwoven fabrics or the like, of natural or synthetic fivers or may consist of protective or barrier layers, e.g. UV filtering layers or the like. In most cases, adhesion is obtained either by physico-chemical bonding arrangements or by mechanical integration of the surface fibers of the covering layer in the surface layer.

Particularly, when the covering layer is made of synthetic leather and/or other types of material, an adhesive layer is advantageously provided between the mat face and the synthetic leather layer, which layer may form one or both layers 3, 3′ or an additional interposed layer between the layers 3, 3′ and the synthetic leather layers 8, 8′. The two layers 3, 3′ and 8, 8′, as well as any additional layers, may be also different from each other.

The starting mat 1 has a weight of 100 to 4000 g/m², preferably of 1000 to 3000 g/m². By the forming compression, the thickness of the starting mat 1 is reduced by 20% to 99% and if possible even more.

Heating is provided in such a manner as to submit for a predetermined short time period of approximately few seconds to approximately 100 seconds the surfaces of the mat 1 to a violent heating. The temperature of the violent heating at the faces of the panel is a temperature which is higher than the melting point of the thermoplastic material, particularly of the thermoplastic material having the highest melting temperature when the fibers comprises a blend of several kinds of thermoplastic materials having different melting and/or softening temperatures.

Violent surface heating may be provided in different manners, e.g. by hot fluid flows, for instance hot air, passing over the sheet 1 with or without the layers 3, 3′ or any additional layers or by radiation, i.e. IR heating, or by direct contact with rigid hot walls. Best results has been obtained by violent heating at the faces of the mat 1 by means of infrared radiation.

The violent heating step is carried out immediately prior to the forming process. The heating operation may be continued during the forming process, or be also solely provided during it. The Figure shows the heating arrangement by associating the mold parts 107, 207 with forming surface heating means, which are designated by numeral 307.

The heating temperature obviously depends on the type of thermoplastic material in use and is generally higher than the melting point, or a temperature, whereat the thermoplastic material loses its fibrous form and turns into a viscous or viscoelastic phase at least partly, preferably completely at the heated face or faces of the mat and at the depths of penetration along the thickness of the panel immediately following the surfaces. The fibrous structure tends to disappear, at least partly, preferably completely.

Heating temperatures typically range from 100 to 300° C., particularly from 160 to 200° C. and typical heating times are of the order of 10 seconds or less to 200 seconds, preferably 20 to 100 seconds.

According to a variant embodiment, the heating temperature may be also locally varied over the different portions of the surface of the mat 1.

Heating methods and temperatures are highly important for the inventive panel fabrication process. In fact, heating temperature variations as a function of the depth within the panel thickness control the extent whereto the plastic material loses its fibrous phase along the thickness of the panel. An additional parameter that affects this loss or retention of the fibrous phase and change to a viscous or viscoelastic form of the plastic fibers is the amount of thickness reduction in the mat 1 during the panel forming process.

Due to these phase changes in the plastic material, depending on the depth within the thickness of the panel 1, fibrous components and/or viscous or viscoelastic components of the plastic materials coexist, prevail or are solely present at different depths within the thickness of the panel.

By selecting heating means types, and controlling absolute heating temperature and heating times, as well as the final panel thickness, a function may be determined for controlling variations in the relative distribution of fibrous components and viscous or viscoelastic components of the material, i.e. the phase variation of the thermoplastic material along the thickness of the panel.

The distribution function of the components of the panel in the different phases along the thickness of the panel is a continuous function and may be either symmetric or asymmetric with respect to the median plane and the variation with depth may have a steep gradient, i.e. higher than 1, or a non steep gradient, i.e. lower than 1.

Preferably, the viscous or viscoleastic component is prevalent and is at the most in a thin surface layer on one or both faces of the panel, whereas the fibrous component is at the most in the intermediate portion in the panel thickness.

More preferably in the said thin surface layers of limited depth in the direction of the median plane of the panel almost all or all the thermoplastic material is in the viscous or viscoelastic phase, i.e. has lost its fibrous form

FIG. 4 shows a relative distribution of the fibrous components and the viscous or viscoelastic components of the above mentioned type, which shows a bell-shaped curve for the fibrous component, and an inverse function for the viscous or viscoelastic component. FIG. 4 shows an uncovered panel 2, in which the amount of fibrous component is represented by the density of the wavy fiber-designating lines. The fibrous component is prevalent where such wavy lines are closely spaced, whereas the viscous or viscoelastic component is prevalent where the wavy lines are widely spaced.

The prevalence or sole provision of the viscous or viscoelastic component in the surface layer i.e. at small depth of penetration in the thickness of the panel is advantageous because the material in this layer should have the highest flowability, whereas the deformability and flowability is not so critical in the central portion of the panel thickness. The prevalence of the fibrous component in the latter portion provides the panel with mechanical strength and/or flexibility and/or nailability and/or heat and/or acoustic insulation, as well as other properties provided by the fibrous component, as mentioned above.

Heating parameters may be obviously controlled to obtain any distribution of the fibrous components and viscous or viscoleastic components, so that the above properties may be differently adjusted in the resulting panels, which allows the latter to be optimized for its specific purposes, while using the same starting sheet 1.

The method for making formed panels according to this invention also provides formed panels having different thicknesses in different portions, as shown in FIG. 3 by the portions I, II, III. Also, by using different heating parameters for said portions I, II, III, relative distributions of fibrous components and viscous or viscoelastic components of the plastic material may be adjusted to obtain different characteristics of the panel in different portions thereof. Hence, for instance in the portion I, the greater thickness of the panel, possibly combined with a heating action, to ensure that the fibrous component is maintained prevalent with respect to the viscous or viscoelastic component, may provide a certain panel softness in this portion and/or a higher heat and/or acoustic insulation, whereas in the portion II, the smaller thickness and possibly a prevailing or sole viscous or viscoleastic component as compared with the fibrous component ensure a higher panel rigidity. The considerations for the portion I also apply to the portion III.

The relation between the field of use of the finished panel and the relative distribution function of the fibrous component and viscous or viscoelastic component of the plastic material may be determined empirically by simple experiments, in which heating temperatures, heating methods, heating times and compression, i.e. thickness reduction from the starting sheet 1 to the finished panel 2 are suitably adjusted.

FIG. 5 shows a variant embodiment, providing a method in which prior compaction of the starting mat 1 into an intermediate mat 1′ is provided upstream from the forming process.

The compaction process may be included in the same forming process, as shown in FIG. 5 for the sake of simplicity, or form a separate treatment, independent from the forming process, which provides an intermediate product, i.e. an intermediate mat 1′.

The forming method is similar in all respects to the one described above with reference to FIG. 1. However, in this case the starting mat 1 is compacted. This step includes heating of the starting mat 1 immediately before and during or solely immediately before or solely during compaction.

Advantageously, compaction is carried out in a calender and heating is provided at the same time as calendering, for instance by using heated rollers 4 or immediately before clendering. Similarly to what has been described with reference to FIG. 1, in a separate lamination step or during calendering, outer layers 3, 3′ may be attached onto one or both faces of the mat so that said intermediate mat 1′ has one or more covering layers on one or both of its faces, e.g. an adhesive layer.

Heating is carried out in a soft way and at temperatures which are lower than the of the thermoplastic material, particularly of the thermoplastic material having the highest or the lowest softening and/or melting temperature when a mat made of a blend of fibers of different kinds of thermoplastic materials havng different melting and/or softening temperatures.

Conversely, the intermediate step, which is outlined by broken lines, shows an alternative method for attaching a layer onto the intermediate mat 1′, which may be also used for the method of FIG. 1, in addition or alternatively to the other covering methods. Here a material 9 in powder or granular form is distributed over the surface of the intermediate sheet 1′.

The compaction of the intermediate mat, combined with heating, first causes a decrease of air volume in the starting mat 1 and the heated rollers may be used to already define a given relative distribution of the fibrous components and of the viscous or viscoelastic components, i.e. those that lost their fibrous form to facilitate the subsequent panel forming process.

Then, the intermediate mat 1′ may be handled and stored in a compacted form, thereby reducing handling and storage costs. Also, thanks to compaction, the intermediate mat 1′ is relatively rigid and more easily handled by automatic handling means along the processing path to the panel forming station 6.

Also, this mat allows for an easier application of any covering layer or intermediate layer before the forming cycle, which is substantially the same as the one described with reference to FIG. 1.

A panel according to this invention has characteristics that make it suitable for use as an interior trim panel for automotive vehicles, or vehicles of other types.

The inventive panel is also suitable as a building material both for structural elements and for interior and/or exterior coverings. However, it shall be noted that these indications of use shall be intended without limitation, as examples of the versatility of use of the inventive panel.

When the mat of nonwoven thermoplastic fibres is made by a blend of fibres of different kinds of thermoplastic materials the heating and compression process and/or the pre processing in the pre heating and calendering steps can be carried out in such a way as to provide for different functions of variation of the phase for each different kind of thermoplastic material. Particularly when at least two kinds of thermoplastic materials are present in the blend of fibres, than the preheating during or before calendering may be carried out at a temperature which is intermediate between the softening and/or melting temperature of the thermoplastic material having the highest softening and/or melting temperature and the softening and/or melting temperature of the thermoplastic material having the lowest softening and/or melting temperature.

Further to an intermediate product being formed by the preheated and precompressed mat 1′ by calendering a further intermediate product can be provided which is a a flat or plane compressed panel being obtained by the process according to the invention. The flat or plane panel is obtained by violent surface heating and molding in a mold countermold system having plane and parallel forming surfaces.

As a variant the violent heating process and/or the molding step can be stopped before obtaining the desired phase distribution of the thermoplastic materials and the desired thickness of the final formed panel which can be obtained by the said flat panel by a further violent heating step and three dimensional shaping step carried out later on starting form the flat or plane panel and in such a way as to complete the violent heating step for obtaining the desired distribution of the phase of the thermoplastic material along the thickness of the panel and the desired final thickness of the panel.

1. A thermoformable panel comprising interlaced thermoplastic fibers forming a non-woven fabric, pressed under heating to cause al least partial melting of fibers, i.e. at least a partial loss of their fibrous phase and change into a viscous or viscoelastic phase, the relative distributions of the fraction of fibers that retain the fibrous phase and the fraction of plastic material that took the viscous or viscoelastic state depending on the depth thereof in the sheet thickness.

2. A panel as claimed in claim 1, wherein as a function of the depth in the panel thickness the fibers shows a continuous change of phase from a first phase provided at the two opposite faces of the panel and in which phase all or almost all the fibers has been submitted to a melting, i.e. ti a phase transition in which all or almost all the fibers has completely or almost completely lost their fibrous phase into a second phase at an intermediate, preferably central region of the panel where the fibers has completely or almost completely maintained their fibrous phase, i.e. has maintained their shape and individuality.

3. A panel as claimed in claim 1, wherein the plastic component that retained its fibrous phase is preferably in the central portion of the panel thickness.

4. A panel as claimed in claim 1, wherein the distribution of fibrous components and viscous or viscoelastic components of the thermoplastic material is symmetric with respect to the median plane of the panel.

5. A panel as claimed in claim 1, wherein the distribution of fibrous components and viscous or viscoelastic components of the thermoplastic material is asymmetric with respect to the median plane of the panel.

6. A panel as claimed in claim 1, wherein the distribution of fibrous components and of viscous or viscoelastic components of the thermoplastic material within the panel thickness is non linear with respect to the penetration depth along the panel thickness toward the median plane thereof, the viscous or viscoelastic component of the thermoplastic material being larger or prevalent in a thin surface layer or in the two surface layers, whereas the fibrous component is prevalent in the portion of the panel thickness immediately underlying said two opposite surface layers.

7. A panel as claimed in claim 6, wherein the variation in the relative distribution of the fibrous and viscous or viscoelastic components of the thermoplastic material toward increase of the fibrous component as compared with the viscous or viscoelastic component is fast, i.e. is controlled by a ripid gradient function, i.e a gradient function being more ripid than a linear function with a parameter 1, as the depth in the panel thickness increases toward the median plane, at least from one of the two surface layers.

8. A panel as claimed in claim 6, wherein the variation in the relative distribution of the fibrous and viscous or viscoelastic components of the thermoplastic material toward increase of the fibrous component as compared with the viscous or viscoelastic component is slow and gradual, i.e. is controlled by a non ripid gradient function, i.e a gradient function being less ripid than a linear function with a parameter 1, as the depth in the panel: thickness increases toward the median plane, at least from one of the two surface layers.

9. A panel as claimed in claim 9, wherein the thermoplastic material is a blend of at least two kinds of thermoplastic fibers having different melting and/or softening temperatures the said blend of thermoplastic fibers having the following continuous phase variation as a function of the depths of penetration:
a first phase provided at the two opposite faces of the panel and in which phase all or almost all the fibers of the at least two kind has been submitted to a melting, i.e. a phase transition in which all or almost all the fibers of the at least two kind has completely or almost completely lost their fibrous phase into a second phase at an intermediate, preferably central region of the panel where both the fibers of the at least two kind the fibers of only one kind has completely or almost completely maintained their fibrous phase, i.e. has maintained their shape and individuality, passing through intermediate phases at intermediate depth of penetration in the thickness of the panel where the fibers of one kind has a more rapid change as a function of penetration in the thickness depth than the fibers of the at least second kind, thereby providing at intermediate penetration depth between the surface of the panel and the central portion a first kind of fibers having a prevalent part of them in a fibrous phase and at least a second part of fibers having a prevalent part or almost all of them in a viscous or viscoelastic phase and/or with further increase in the depth of penetration toward the central portion of the panel a first part of fibers having a prevalent part or almost all of them a fibrous phase while the at least second kind of fibers having formed physico-chemical bandings between the first kind of fibres.

10. A panel as claimed in claim 1, wherein the thermoplastic material comprises one polyolefin or a mixture of polyolefins.

11. A panel as claimed in claim 9, wherein the thermoplastic material is made of polymer or copolymer fibers from the polyethylene group or mixtures thereof.

12. A panel as claimed in claim 9, wherein the thermoplastic material is made of polymer or copolymer fibers from the group of polyethylene ethers or mixtures thereof.

13. A panel as claimed in claim 12, wherein the thermoplastic material is composed of polyethylene glycol ether phthalate terpolymer.

14. A panel as claimed in claim 1, wherein the thermoplastic fibers are randomly oriented.

15. A panel as claimed in claim 1, wherein it is made out of thermoplastic fibers by heating a mat having one or more nonwoven fabric layers of said thermoplastic fibers, which layers are joined together by interlacement and/or heat bonding (self bonding), said mat of nonwoven fabric layers being submitted to violent or hard heating at a predetermined melting and/or softening temperature of the fibers which is considerably higher than the melting temperature of the plastic fibers of the panel having the highest melting or softening temperature and for a predetermined time, and being further submitted to a compression to such an extent as to cause a thickness reduction from the uncompressed condition to the compressed condition by about 30% to about 90% of the uncompressed thickness of the mat made of the nonwoven fabric layers.

16. A panel as claimed in claim 1, wherein heating is provided by radiation.

17. A panel as claimed in claim 1, wherein heating is provided by infrared radiation.

18. A panel as claimed in claim 1, wherein heating is provided in one step or in subsequent steps.

19. A panel as claimed in claim 1 wherein the panel is formed by a hot air flow and/or radiation and/or direct contact with hot surfaces.

20. A panel as claimed in claim 1, wherein at least one of the hot heating surfaces consist of at least one surface of a compression mold used for thermoforming by I mold and countermold systems and/or hydraulic and/or I pneumatic pressure and/or vacuum.

21. A panel as claimed in claim 1, wherein a preheating and preventive compression phase is provided in which compression of the mat made of nonwoven fabric layers and heating are performed by calendering with heated rollers at a temperature lower than the melting or softening temperature of the thermoplastic fibers.

22. A panel as claimed in claim 1, wherein the heating temperature at the mat surface is of 100° C. to 300° C., and particularly of 160° C. to 200° C.

23. A panel as claimed in claim 1, wherein the mat made of nonwoven fabric layers has a weight of 100 to 4000 g/m2, preferably of 1000 to 3000 g/m².

24. A panel as claimed in claim 1, wherein the sheet and the mat made of nonwoven fabric layers have, on one or both faces thereof and/or in an intermediate position of one or more layers, a net, a thermoplastic fiber fabric attached by physico-chemical bonding, particularly by heat bonding.

25. A panel as claimed in claim 1, wherein an adhesive layer is provided on one or both faces.

26. A panel as claimed in claim 23, wherein the adhesive material consists of a polyolefin based polymer or copolymer layer, which is surface-treated to increase polarity.

27. A panel as claimed in claim 1, wherein it is an intermediate or semi-finished product for the fabrication of thermoplastic formed panels by further molding the panel in a mold under heat and compression.

28. A panel as claimed in claim 1, wherein the panel has a non plane shape being formed in three dimensions in the compression stage by a mold and countermold system.

29. A panel as claimed in claim 1, wherein the portions of the panel thickness in which all or almost all the fibers or a prevalent number of fibers has a viscous or viscoelastic phase are thin surface layers.

30. A panel as claimed in claim 1, wherein a covering layer made of fabric, nonwoven fabric, mesh or interlaced synthetic or natural fibers, a thin plastic sheet, a leather or imitation leather sheet and/or combinations thereof are attached on at least one of the panel surfaces, on different portions of said panel.

31. A panel as claimed in claim 30, wherein the covering layer is made of a single layer.

32. A panel as claimed in claim 1, wherein the covering layer is made of several layers and comprises at least one additional adhesive layer interposed between the thermoplastic layer and the covering layer.

33. A panel as claimed in claim 32 wherein the covering layer further includes an outer finishing layer, composed of a thin thermoplastic sheet, like a scratch resistant sheet or a UV-filtering sheet.

34. A formed panel as claimed in claim 1, wherein the panel has coating layer as claimed in one or more of the preceding claims 33 to 24 also on both faces.

35. A panel as claimed in claim 1, wherein the panel has smooth surfaces.

36. A method for fabricating a thermoformable panel comprising the steps of:
a) providing a mat of thermoplastic fibers;
b) heating the mat to a temperature higher than the melting or softening temperature of the plastic material of the fibers having the highest melting or softening temperature; and
c) compressing the mat to such an extent to obtain a 30% to 90% reduction of the starting thickness of the mat.

37. A method as claimed in claim 36, wherein the fiber mat is made of randomly oriented thermoplastic fibers.

38. A method as claimed in claim 36 or 37, wherein the fiber mat is made of a plurality of layers of interlaced thermoplastic fibers.

39. A method as claimed in claim 36, wherein the fiber mat is made of interconnected fabric or nonwoven fabric layers of thermoplastic fibers not being needled.

40. A method as claimed in claim 36, wherein the fibrous layers are interconnected by mechanical interlacement and/or by physico-chemical bonding, particularly by heat bonding.

41. A method as claimed in claim 36, wherein the uncompressed fiber mat has a weight of 100 to 4000 g/m², preferably of 1000 to 3000 g/m².

42. A method as claimed in claim 36, wherein heating is provided by infrared radiation on the outer faces of the fiber mat immediately before compression.

43. A method as claimed in claim 36, wherein heating is provided by contact with hot heater elements against the fiber mat immediately before compression and/or during it and/or solely during compression.

44. A method as claimed in claim 36, wherein the mat is heated to a temperature of 150° C. to 300° C., preferably of 200° C. to 250° C. for a time varying between and 100 seconds.

45. A method as claimed in claim 36, wherein a further step of compressing the mat by calendering is provided before heating.

46. A method as claimed in claim 45, wherein a preheating at a temperature lower than the melting temperature of the fibers is carried out during calendering, the calender rollers being heated rollers.

47. A method as claimed in claim 36, wherein heating provides a transition in the state of a portion of the thermoplastic fibers from the fibrous state to a at least partially or completely viscous or viscoelastic state for a certain depth of penetration in the thickness of the of the panel starting from at; least one surface of the panel by heating the mat with infrared radiation directed on said surface or surfaces, whereby the plastic material at these depth of penetration in the thickness of the panel has a larger component of plastic material in a viscous or viscoelastic phase as compared with the component plastic material in the fibrous phase, the viscous or viscoelastic component gradually and continuously decreasing toward the median portion of the panel until the distribution of viscous or viscoelastic plastic material and fibrous plastic material is inverted in said median portion, wherein the component of plastic material in the fibrous phase prevails over the component of plastic material in the viscous or viscoelastic phase.

48. A method according to claim 47, wherein heating provides a transition in the state of a portion of the thermoplastic fibers from the fibrous state to a at least partially or completely viscous or viscoelastic state of a portion of all or almost all the thermoplastic fibers for a certain depth of penetration in the thickness of the of the panel starting from at least one surface of the panel by heating the mat with infrared radiation directed on said surface or surfaces, whereby the plastic material at these depth of penetration in the thickness of the panel has almost only a component of plastic material in a viscous or viscoelastic phase as compared with the component plastic material in the fibrous phase, the viscous or viscoelastic component gradually and continuously decreasing toward the median portion of the panel until the distribution of viscous or viscoelastic plastic material and fibrous plastic material is inverted in said median portion, wherein the component of plastic material in the fibrous phase prevails over the component of plastic material in the viscous or viscoelastic phase or almost only the component of the plastic material in the fibrous phase is present.

49. A method as claimed in claim 36, further comprising the step of attaching a fabric layer or a thermoplastic net layer, on one or both faces of the fiber mat, when the latter is uncompressed or compressed or during the compression step.

50. A method as claimed in claim 36, further comprising the step of attaching an adhesive layer on one or both faces of the sheet.

51. A method as claimed in claim 50, wherein the fabric or net layer and/or the adhesive material are attached during the compression step thanks to the physico-chemical bonding generated as the mat and/or the fabric or the net and/or the adhesive are heated.

52. A method as claimed in claim 51, wherein the adhesive is provided as a thin sheet and is attached to the fiber mat during the compression step by hot calendering, by feeding it to the calender rollers over the face/s of the fiber mat.

53. A method as claimed in claim 51, wherein the fabric and/or the net are attached to the fiber mat during the compression step by hot calendering, by feeding them to the calender rollers over the face/s of the fiber mat.

54. A method as claimed in claim 51, wherein the thin adhesive layer and the fabric and/or the net are attached together, one over the other, and onto the face/s of the mat upon during the calendering step.

55. A method as claimed in claim 36, wherein the adhesive is applied in powder form, by spreading it over at least one face of the mat in the uncompressed or compressed condition thereof before heating, and by heating said adhesive powder.

56. A method as claimed in claim 36, wherein it is adapted to produce a thermoformable panel to be used as an intermediate or semi-finished product for the fabrication of formed panels.

57. A method as claimed in claim 56, wherein the intermediate or semi-finished panel is submitted to thermoforming for producing a shaped panel in the three dimensions.

58. A method as claimed in claim 57, wherein the panel is heated before forming and or during forming to a softening temperature of the plastic material which is lower that the melting temperature of the thermoplastic fibers and submitted during heating and or after to three dimensional shaping by mechanical compression in a mold and countermold system and/or by compression against a formed surface by using hydraulic and/or pneumatic pressure and/or vacuum against a formed surface and/or by hydraulic and/or pneumatic compression and vacuum.

59. A method as claimed in claim 36, wherein the mat of fibers is submitted to compression for simultaneous thickness reduction and three dimensional shaping obtaining a three dimensional shaped panel by mechanical compression in a mold and countermold system and/or by compression against a formed surface by using hydraulic and/or pneumatic pressure and/or vacuum against a formed surface and/or by hydraulic and/or pneumatic compression and vacuum.

60. A method as claimed in claim 36, wherein before applying a compression for thickness reduction and three dimensional shaping on the heated mat it includes the further steps of:
feeding one or more covering layers for at least one of the sheet faces, one over the other and over the mat or the flat panel to be compressed and/or shaped; and
simultaneously attaching the covering layer/e to the sheet during the compression and/or shaping process.

61. A method as claimed in claim 60, further comprising the additional step of attaching an adhesive layer on the face/s of the panel and/or of the mat of fibers which adhesive layer: or layers are designed to be coupled to one or more covering layers.

62. A method as claimed in claim 61, wherein the adhesive consists of a thin thermoplastic layer which is fed and coupled to the panel or mat of fibers on at least one of the two faces thereof before forming and coupling the covering layer/s or while coupling the covering layer/s, the thin layer being fed with the sheet and the covering layers to the forming station.

63. A method as claimed in claim 36, wherein, before or during the process for compressing and or forming the panel or the mat of fibers and/or the covering layer/s and/or the adhesive layer/s, the sheet and/or the covering layer/s and/or the adhesive layer are heated together with the panel or mat of fibres or separately.

64. A method as claimed in claim 63, further comprising the step of heating together the mat of fibers and the covering layer/s and/or the adhesive layer to a temperature of 100° C. to 300° C., particularly of 160° C. to 200° C. and for a time of 10 to 100 seconds.

65. A method claim 36, further comprising the step of coupling the covering layer/s and/or the adhesive layer to the mat of fibers during calendering.

66. A thermoformable panel comprising interlaced thermoplastic fibers forming a non-woven fabric, pressed under heating to cause al least partial melting of fibers. i.e. at least a partial loss of their fibrous phase and change into a viscous or viscoelastic phase, the relative distributions of the fraction of fibers that retain the fibrous phase and the fraction of plastic material that took the viscous or viscoelastic state depending on the depth thereof in the sheet thickness, wherein the thermoformable panel comprises portions with different thicknesses.

67. A panel as claimed in claim 66, wherein, in the portions having different thicknesses, a different function is provided for the variations in the distribution of the component having fibrous phase and of the component having an elastic or viscoelastic phase of the plastic material, depending on the penetration depth in said thickness of the panel.

68. A method as claimed in claim 36, wherein the mat of fibers is heated at different temperatures in different portions of the surfaces of the said mat and/or submitted to different reduction of thickness in different portions of the surface of the mat by compressing the mat in a differential manner in said different portions.

69. A method as claimed in claim 36, wherein the panel is heated at different temperatures in different portions of the surfaces of the said panel and/or submitted to: different reduction of thickness in different portions of the surface of the said panel by compressing the panel in a differential manner in said different portions during shaping.

70. A panel as claimed in claim 1, wherein it is used as an interior covering panel for vehicles, particularly automotive vehicles and especially a so called interior trim for automotive vehicles.

71. A panel as claimed in claim 1, wherein it is used as an interior or exterior covering panel for building structures and/or a panel for formworks containing concrete or the like.

72. A formed panel as claimed in claim 1, wherein it is used as an interior or exterior covering panel or a structural element for ships and/or railway vehicles, especially of the high speed type and/or for aerospace vehicles.

73. A method as claimed in claim 36, wherein it is a method for fabricating interior covering panels for vehicles, particularly automotive vehicles and especially a so-called interior trim for automotive vehicles.

74. A method as claimed in claim 36, wherein it is a method for fabricating interior or exterior covering panels, for building structures and/or panels for formworks containing concrete or the like.

75. A method as claimed in claim 36, wherein it is a method for fabricating interior or exterior covering panels or structural elements for ships and/or railway vehicles, especially of the high speed type and/or for aerospace vehicles.

76. A method as claimed in claim 36, wherein the method steps further comprise:
a) providing a mat of thermoplastic fibers in which only a kind of thermoplastic fibres is comprised or a blend of at least two different kinds of thermoplastic fibres are comprised having different melting and or softening temperatures, and calendering the mat of thermoplastic fibers while heating it at a temperature lower than the melting and/or softening temperature of the thermoplastic fibers having the highest or the lowest melting and/or softening temperatures or after having heated the mat at the said temperature lower than the melting and/or softening temperature of the thermoplastic fibers having the highest or the lowest melting and/or softening temperatures;
b) heating the mat to a temperature higher than the melting or softening temperature of the thermoplastic fibers having the highest melting or softening temperature by hard or violent heating the panel on one or both faces through infrared radiation directed against the said one or both faces of the panel;
c) compressing the heated mat in a mold having two complementary shaped molding matrices and cooling the panel.

77. A method according to claim 76, wherein the compression is exercised to such an extent to obtain a 30% to 90% reduction of the starting thickness of the mat.

78. A process for obtaining an intermediate product for a thermoformable panel comprising interlaced thermoplastic fibers forming a non-woven fabric, wherein a mat of nonwoven thermoplastic fibers mat is submitted to heating at a temperature which is lower than the softening and/or melting temperature of the thermoplastic material of the fibers having the highest softening and/or melting temperature and is calendered, heating being carried out during or immediately before calendering.

79. A process for producing an intermediate product claim 78, wherein it comprises the steps of submitting to a violent surface heating a mat of thermoplastic fibres either directly or after preheating at a lower temperature than the softening and/or melting temperature of the thermoplastic material of the fibres having the highest or the lowest softening and/or melting temperature and calendering the said mat of fibres, heating being carried out during or immediately before calendering and molding the said violently heated mat in a mold countermold system having plane and parallel forming surfaces.

80. A method according to claim 79, wherein the violent heating process and/or the molding step are stopped before obtaining the desired phase distribution of the thermoplastic materials and the desired thickness of the final formed panel.

81. A method according to claim 80, wherein a final thermoformed panel is obtained from the said flat panel by a further violent heating step and three dimensional shaping step carried out at later stage on starting form the said intermediate flat or plane panel and in such a way as to complete the violent heating step for obtaining the desired distribution of the phase of the thermoplastic material along the thickness of the panel and the desired final thickness of the panel.

82. A method according to claim 80, wherein the final panel is flat or plane.

83. A method according to claim 80, wherein the hard or violent heating of the fibres is carried out by violently transferring a certain amount of thermal energy, i.e. heating with a certain temperature of the heaters and for a predetermined time and using heaters which heat transfer mean has a low thermal capacity.
